(19) United States
(12) Patent Application Publication
(10) Pub. No.: US 2026/0357613 A1
(43) Pub. Date: Nov. 12, 2026

(54) ELECTRONIC APPLIANCE DOOR-LOCK APPARATUS COMPRISING SWITCHING DEVICE

(71) Applicant: DUAL POWER ELECTRONICS CO., LTD, Jeongeup-si, Jeollabuk-do (KR)

(72) Inventors: Jang-Joo LIM, Seoul (KR); Sang-Won SUH, Jeongeup-si (KR); Jung Gil LEE, Jeongeup-si (KR); Hee Chang KIM, Jeongeup-si (KR)

(73) Assignee: DUAL POWER ELECTRONICS CO., LTD, Jeongeup-si, Jeollabuk-do (KR)

(21) Appl. No.: 19/122,577

(22) PCT Filed: Oct. 31, 2022
(86) PCT No.: PCT/KR2022/016829

§ 371 Date: Apr. 18, 2025

(30) Foreign Application Priority Data
Oct. 24, 2022 (KR) 10-2022-0137669

(51) Int. Cl. E05B 17/22; E05B 15/04; E05B 47/00

(52) U.S. Cl. CPC E05B 17/22; E05B 15/04; E05B 47/0012; E05B 2015/0448

(57) ABSTRACT

A door-lock apparatus according to an embodiment of the present invention comprises: a main body cover having a space formed therein; a motor installed in the main body cover and providing a driving power; and a switching device, wherein the switching device comprises: a switch lever of which one end portion faces the direction of a door; a first spring providing the switch lever with a recovery force in one direction; a first terminal and a second terminal which are conductive terminals installed to be spaced apart from each other and generate or block a connection signal; a connection terminal which is installed between the first terminal and the second terminal and connects or disconnects the two terminals; and a second spring which is attached to the connection terminal and provides a recovery force in a direction opposite to the first spring.

### TECHNICAL FIELD

The present invention relates to a door lock device for home appliance and more particularly, to a door lock device including a switching device mounted to a washing machine, a dryer, and the like.

### RELATED ART

Various home appliances are present in our daily lives. In particular, In the case of a washing machine, a dryer, a dishwasher, a microwave oven, and the like, which are used by putting contents in them, a door may be installed to block the contents from the outside and a locking device that opens and closes the door is an essential component that constitutes a corresponding home appliance.

Various technologies related to a door lock device have been developed until recently. Representative inventions include Korean Patent Registration No. 10-1667916 (push-and-push door lock device), Korean Patent Registration No. 10-1915250 (manual door lock device), and the like.

The push-and-push door lock device describes a door lock device that automatically opens a door without a need for a user to open the door, when an operation of a home appliance is terminated.

The push-and-push door lock device is installed in a main body, and includes a release button configured to release a binding force of a fixing member by a sliding operation and a driving unit configured to selectively control door holding, door locking, and automatic door opening operations by a rotational motion of a rotational shaft equipped with a cam protrusion on one side.

The door lock device needs to be externally indicated such that a user may be aware of a case in which the door is closed by the user or a case in which the door is automatically opened. To this end, a switching device needs to be installed in the door lock device. The switching device needs to be installed at a location adjacent to the door lock device to enable or disable a signal to the door lock device and to accurately determine an open/closed state of the door.

Therefore, the switching device may be generally installed within the door lock device for home appliance. However, since the switching device needs to move steadily according to the number of times the door is opened and closed, durability needs to be guaranteed and connection and disconnection between contact terminals needs to be performed naturally.

U.S. Pat. No. 8,193,461 relates to “Electrical switch, particularly of microswitch design” and FIG. 1 is a representative drawing of U.S. Pat. No. 8,193,461 that is prior art.

In the related art, a spring 40 is provided between two conductive pins 50 and 60, and when an actuating element 30 is pressed, the spring 40 releases connection between the conductive pins 50 and 60, and when it returns, the spring 40 connects the two conductive pins 50 and 60.

However, this switching structure is a medium that a spring uses to connect two pins. Here, the spring needs to be made of a metal material and, since resistance of conductive metal increases, there is the risk that a signal is not delivered. Also, due to functional characteristics of the spring, contraction and tension may be repeated, which may affect durability.

### DETAILED DESCRIPTION

### Technical Subject

An objective of the present invention is to provide a door lock device combined with a switching device having enhanced durability.

### Solution

A door lock device according to an example embodiment of the present invention relates to a door lock device including a main body cover having a space formed inside, a motor installed inside the main body cover to provide a driving force, and a switching device, and the switching device includes a switch lever of which one end faces the direction of a door; a first spring configured to provide a restoring force to the switch lever in one direction; a first terminal and a second terminal that are conductive terminals installed to be spaced apart from each other and to generate or block a connection signal; a connecting terminal installed between the first terminal and the second terminal and configured to connect or disconnect the two terminals; and a second spring attached to the connecting terminal and configured to provide a restoring force in a direction opposite to that of the first spring.

As an example embodiment, the switch lever includes a main body configured to be in direct contact with the door; a slide track configured to induce a linear movement of the main body; a spring receiving hole through which the first spring is received; and a protruding bar attached to one side of the main body and configured to be in contact with the connecting terminal.

As an example embodiment, the first terminal and the second terminal are in a hook shape of which one end is in a flattened “U” shape, the connecting terminal includes a coupling portion configured to couple to the second spring and a single pair of wings formed on both sides of the coupling portion, and the single pair of wings connect or disconnect the first terminal and the second terminal by linearly moving in space between the first terminal and the second terminal of which one ends are hook-shaped.

As an example embodiment, the connecting terminal includes a groove portion recessed for coupling of the second spring.

### Effect

A door lock device according to an example embodiment of the present invention has a relatively simple structure, so manufacturing cost is relatively low and durability may be secured.

Also, a switching device with enhanced durability compared to the existing door lock device is included.

Also, a consumer may easily handle with a possible failure of a door lock device.

### BRIEF DESCRIPTION OF DRAWINGS

FIG. 1 is a representative view of U.S. Pat. No. 8,193,461 that is prior art.

FIG. 2 is a front view of a door lock device according to an example embodiment of the present invention.

FIG. 3 is a view illustrating a state in which a switching device is mounted to a main body cover.

FIGS. 4 and 5 illustrate the detailed structure of a switching device.

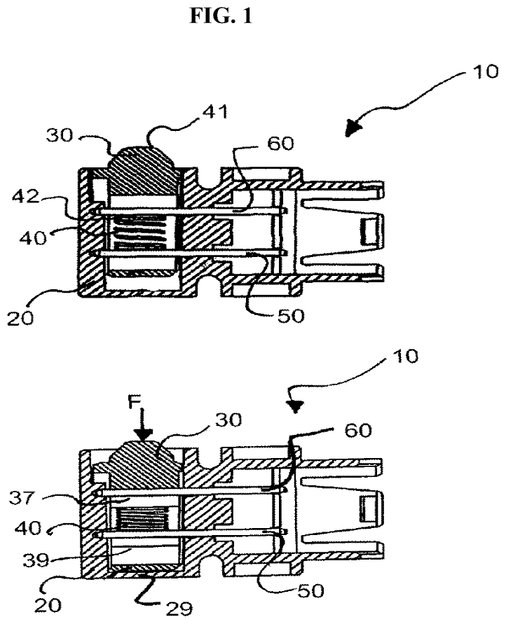

### BEST MODE

The specific structural or functional descriptions of example embodiments according to the concept of the present invention disclosed herein are merely intended for the purpose of describing the example embodiments according to the concept of the present invention and the example embodiments according to the concept of the present invention may be implemented in various forms and are not construed as limited to the example embodiments described herein.

Various modifications may be made to the example embodiments according to the concept of the present invention and thus, the example embodiments are illustrated in the drawings and described in detail through the present specification. However, it should be understood that the example embodiments according to the concept of the present invention are not construed as limited to specific implementations and should be understood to include all changes, equivalents, or replacements within the idea and the technical scope of the present invention.

Although terms of “first,” “second,” and the like are used to explain various components, the components are not limited to such terms. These terms are used only to distinguish one component from another component. For example, a first component may be referred to as a second component, or similarly, the second component may be referred to as the first component without departing from the scope according to the concept of the present invention.

When it is mentioned that one component is “connected” or “accessed” to another component, it may be understood that the one component is directly connected or accessed to another component or that still other component is interposed between the two components. In addition, when it is described that one component is “directly connected” or “directly accessed” to another component, it should be understood that still other component is absent therebetween. Likewise, expressions describing relationships between components, for example, “between” and “immediately between” and “immediately adjacent to” may also be construed as described in the foregoing.

The terminology used herein is for the purpose of describing particular example embodiments only and is not to be limiting of the present invention. As used herein, the singular forms “a,” “an,” and “the” are intended to include the plural forms as well, unless the context clearly indicates otherwise. It will be further understood that the terms “comprises/includes” or “has,” when used in this specification, specify the presence of stated features, integers, stages, operations, components, parts, or combinations thereof, but do not preclude the presence or addition of one or more other features, integers, stages, operations, components, parts, or combinations thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments of the present invention will be described in detail with reference to the accompanying drawings. However, the scope of the patent is not limited or restricted by the example embodiments. Like reference numerals presented in the respective drawings refer to like components.

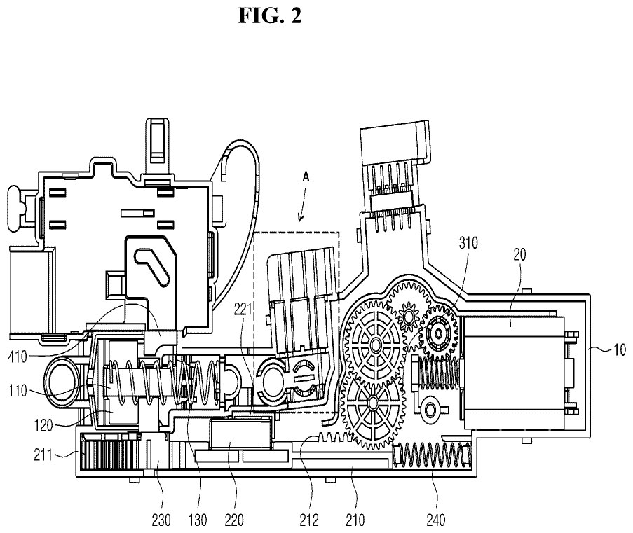

FIG. 2 is a front view of a door lock device according to an example embodiment of the present invention.

As shown in FIG. 2, the door lock device according to an example embodiment of the present invention relates to a door lock device that includes a main body cover 10 having a space formed inside, and a motor 20 installed inside the main body cover 10 and configured to provide a driving force, and is designed such that devices for driving may be installed in the internal space of the main body cover 10.

In particular, in the door lock device according to an example embodiment of the present invention, a separate space A is formed such that a switching device 500 may be installed.

In detail, the configuration of the door lock device according to an example embodiment of the present invention includes a locker 110 configured to couple to or separate from a hook (not shown) introduced from the outside through rotation, a locker shaft 120 of which one end is connected to the locker 110 and formed at the center of rotation of the locker 110, a clutch gear 230 configured to connect to the other end of the locker shaft 120 and to induce rotation of the locker 110, a locker spring 130 configured to connect to one side of the locker 110 and to provide a rotational restoring force to the locker 110, a rack slide 210 configured to provide a rotational force of the motor 20 to the locker 110 through the clutch gear 230, and a pinion gear 310 configured to transmit the rotational force of the motor 20 to the rack slide 210.

The locker 110 is generally a portion to which a hook (not shown) attached to a door of a home appliance is fastened and is configured to be rotatable at a predetermined angle. The locker 110 is a portion to which the hook is fastened and directly receives load, and may be made of a metal alloy or a plastic material that ensures strength as much as possible. The locker 110 may be implemented in various shapes, and may be in an angular ring shape with one side open.

The locker 110 is designed to rotate at a set angle, and when a fastening portion of the hook inserts into the locker 110, the locker 110 may rotate to prevent the hook from being separated in the same direction. Also, the locker 110 may rotate back to the angle at which the hook is introduced and the hook may be disengaged accordingly.

One end of the locker shaft 120 is connected to the locker 110. The locker shaft 120 may be integrally formed with the locker 110, but may also be firmly assembled with the locker 110. In particular, the locker shaft 120 may simultaneously perform the function of a rotating shaft on which the locker 110 rotates.

The clutch gear 230 is connected to the other end of locker shaft 120 and induces rotation of the locker 110. The clutch gear 230 is in a shape in which gear teeth are formed on the outer surface of a hollow cylinder with one end open. The clutch gear 230 is firmly coupled at the other end of the locker shaft 120 and transmits the rotational fore transmitted through the clutch gear 230 to the locker 110 through the locker shaft 120.

The locker spring 130 is connected to one side of the locker 110, more specifically, to the opposite side of a portion to which the hook is coupled based on the locker shaft 120. Also, one end of the locker spring 130 is fixed to a partition wall of the main body cover 10 and, through this, the locker spring 130 provides a continuous elastic force to the locker 110. The locker spring 130 applies the elastic force toward the locker 110 at all times. As shown in FIG. 2, in the case of connecting the locker spring 130 to the locker 110, the locker 110 may maintain an angle of rotation in an always-closed state or in an always-open state.

That is, the locker 110 may not be in an intermediate state between closed or open due to the elastic force (repulsive force or force of restitution) applied by the locker spring 130, the elastic force (repulsive force or force of restitution) is continuously applied to maintain the closed state in which the hook is introduced, and when the locker 110 is in the open state by removing the hook from the locker 110 due to an external force, the locker 110 is maintained in the open state by way of the locker spring 130 unless another external force is applied.

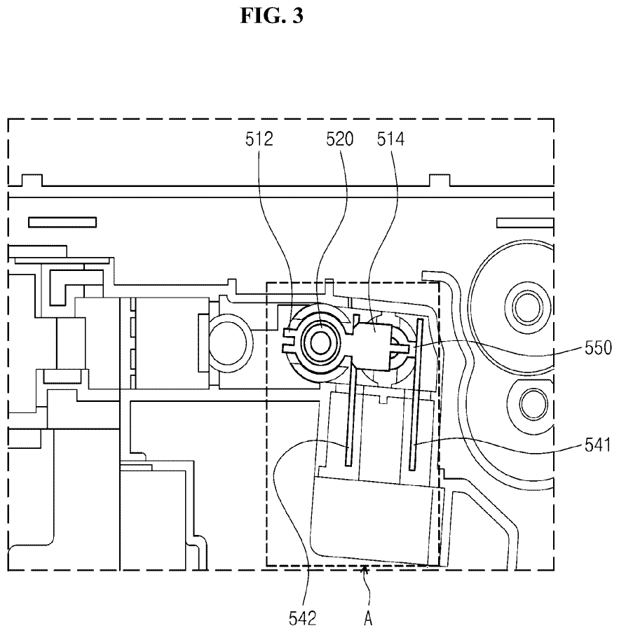

Among the components of the door lock device according to an example embodiment of the present invention, some components related to locking and opening functions of the door are described. Hereinafter, the switching device 500 of the door lock device according to an example embodiment of the present invention is described with reference to FIGS. 3 to 5.

FIG. 3 is a view illustrating a state in which a switching device is mounted to a main body cover.

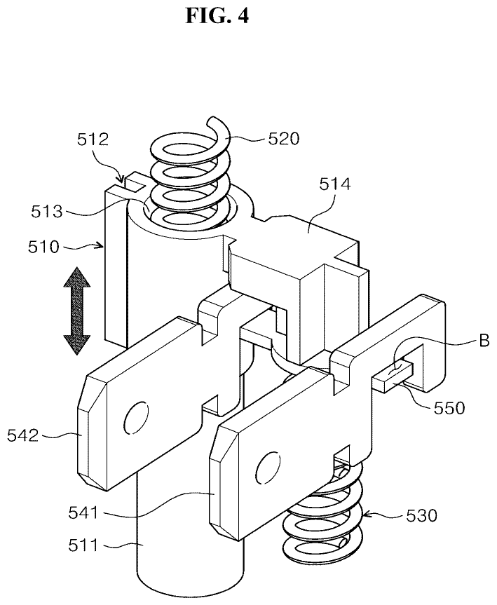

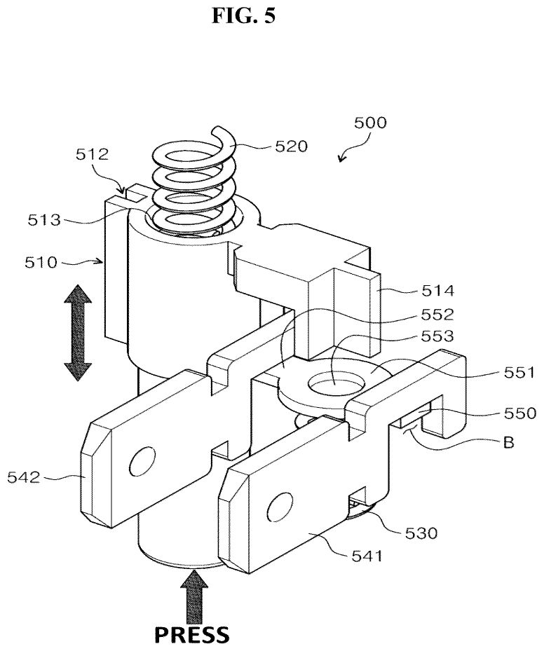

FIGS. 4 and 5 illustrate the detailed structure of a switching device.

As shown in FIGS. 3 to 5, the switching device 500 according to an example embodiment of the present invention includes a switch lever 510 of which one end faces the direction of a door and of which the other end is formed with a spring receiving hole 513, a first spring 520 configured to provide a restoring force to the switch lever 510 in one direction, a first terminal 541 and a second terminal 542 that are conductive terminals installed to be spaced apart from each other and to generate or block a connection signal, a connecting terminal 550 installed between the first terminal 541 and the second terminal 542 and configured to connect or disconnect the two terminals, and a second spring 530 attached to the connecting terminal 550 and configured to provide a restoring force in a direction opposite to that of the first spring 520.

The switch lever 510 may be made of a non-conductive material, and may be made of a plastic material. In particular, the switch lever 510 may be made of a durable material due to the functional characteristic of the member.

The switch lever 510 includes a main body 511 configured to be in direct contact with the door, a slide track 512 configured to induce a linear movement of the main body 511, the spring receiving hole 513 through which the first spring 520 is received, and a protruding bar 514 attached to one side of the main body 511 and configured to be in contact with the connecting terminal 550.

The main body 511 continuously performs a linear motion of being pushed back through contact with the door that approaches to close the home appliance with the door at one end, and, as the door opens, returning to a state in which there is no contact with the door by the first spring 520 located on the other side.

The switch lever 510 includes the slide track 512, and, as shown in FIG. 3, the slide track 512 couples to the partition wall formed inside the main body cover and induces the main body 511 to only move linearly up and down.

The spring receiving hole 513 is formed at the other end of the switch lever 510, and the first spring 520 is inserted. In detail, the spring receiving hole 513 is installed such that the first spring 520 may be fixed inside the main body 511.

The switch lever 510 includes the protruding bar 514. As shown in FIGS. 3 to 5, the protruding bar 514 provides movement of the main body 511 to the connecting terminal 550. The protruding bar 514 is integrally formed with the main body 511 or rigidly attached thereto and configured to be movable together.

The first spring 520 included in the switching device 500 according to an example embodiment of the present invention provides a thrust to restore the main body 511 toward the door. As described above, the first spring 520 is inserted into the spring receiving hole 513 formed in the switch lever 510 and induces the linear movement according to the movement of the main body 511.

The first terminal 541 and the second terminal 542 are conductive terminals and may be electrically connected to an external terminal, and whether the door is open or closed may be indicated through connection or disconnection between the first terminal 541 and the second terminal 542.

The first terminal 541 and the second terminal 542 are symmetrically provided in the same shape, and in a hook shape of which one end is in a flattened “U” shape.

The switching device 500 according to an example embodiment of the present invention includes the connecting terminal 550. The connecting terminal 550 is installed between the first terminal 541 and the second terminal 542, and connects or disconnects the two terminals.

The connecting terminal 550 includes a coupling portion 551 configured to couple to the second spring 530 to be described below and a single pair of wings 552 formed on both sides of the coupling portion 551. Also, the connecting terminal 550 includes a groove portion 553 that is recessed for coupling of the second spring 530.

The second spring 530 is attached to the connecting terminal 550 and provides a restoring force in the direction opposite to that of the first spring 520.

As shown in FIG. 4, when the switching device according to an example embodiment of the present invention is in a state in which no external force is applied to the main body 511, that is, in a state in which the door is open, the first spring 520 is tensioned and the main body 511 is pushed toward the door. The second spring 530 is in a contracted state in which the connecting terminal 550 is pressed by the protruding bar 514, and the connecting terminal 550 maintains the first terminal 541 and the second terminal 542 in a disconnected state.

As shown in FIG. 4, the single pair of wings 552 of the connecting terminal 550 linearly move in space B between the first terminal 541 and the second terminal 542 of which one ends are hook-shaped.

The first terminal 541 and the second terminal 542 are inserted into the inner partial wall of the main body cover 10 through the hook-shaped terminals. Therefore, the wings 552 of the connecting terminal 550 connect the first terminal 541 and the second terminal 542 by contacting upper portions of the first terminal 541 and the second terminal 542.

As shown in FIG. 5, when the main body 511 is pressed by the door, the first spring 520 is compressed. The pressed main body 511 rises with the protruding bar 514, and the second spring 530 is tensioned and raises the connecting terminal 550 to connect the first terminal 541 and the second terminal 542.

The door lock device according to an example embodiment of the present invention includes the switching device 500, thereby having the improved durability and the reduced risk of switch malfunction. Also, assembly is simplified and productivity is improved by integrally coupling to the main body cover 10 of the door lock device.

Although the present invention is described with reference to the example embodiments illustrated in the drawings, it is provided as examples only and one of ordinary skill in the art will understand that various modifications and equivalent other example embodiments may be made from this. For example, suitable results may be achieved if the described techniques are performed in different order, and/or if components in a described system, architecture, device, or circuit are combined in a different manner, and/or replaced or supplemented by other components or their equivalents. Therefore, the true technical protection scope of the present invention should be determined based on the technical spirit of the claims.

What is claimed is:

1. A door lock device comprising a main body cover having a space formed inside, a motor installed inside the main body cover to provide a driving force, and a switching device, wherein the switching device includes:
a switch lever of which one end faces the direction of a door;
a first spring configured to provide a restoring force to the switch lever in one direction;
a first terminal and a second terminal that are conductive terminals installed to be spaced apart from each other and to generate or block a connection signal;
a connecting terminal installed between the first terminal and the second terminal and configured to connect or disconnect the two terminals; and
a second spring attached to the connecting terminal and configured to provide a restoring force in a direction opposite to that of the first spring.

2. The door lock device of claim 1, wherein the switch lever includes:
a main body configured to be in direct contact with the door;
a slide track configured to induce a linear movement of the main body;
a spring receiving hole through which the first spring is received; and
a protruding bar attached to one side of the main body and configured to be in contact with the connecting terminal.

3. The door lock device of claim 1, wherein the first terminal and the second terminal are in a hook shape of which one end is in a flattened “U” shape, the connecting terminal includes a coupling portion configured to couple to the second spring and a single pair of wings formed on both sides of the coupling portion, and the single pair of wings connect or disconnect the first terminal and the second terminal by linearly moving in space between the first terminal and the second terminal of which one ends are hook-shaped.

4. The door lock device of claim 3, wherein the connecting terminal includes a groove portion recessed for coupling of the second spring.
